(19) United States
(12) Patent Application Publication
(10) Pub. No.: US 2016/0186932 A1
(43) Pub. Date: Jun. 30, 2016

(54) PROCESS FOR FILLING A SORPTION STORE WITH GAS

(71) Applicant: BASF SE, Ludwigshafen (DE)

(72) Inventors: Matthias WEICKERT, Ludwigshafen (DE); Stefan MARX, Dirmstein (DE); Ulrich MÜLLER, Neustadt (DE); Peter RENZE, Mannheim (DE)

(21) Appl. No.: 14/911,747

(22) PCT Filed: Aug. 12, 2014
(86) PCT No.: PCT/IB2014/063869

§ 371 Date: Feb. 12, 2016

(30) Foreign Application Priority Data
Aug. 15, 2013 (EP) 13180512.9

(51) Int. Cl. F17C 11/00; F17C 5/06

(52) U.S. Cl. CPC F17C 11/007; F17C 5/06; F17C 2250/03; F17C 2221/033; F17C 2227/04; F17C 2270/01

(57) ABSTRACT

A process for filling a sorption store (50) with a gas (51), wherein at least one gas adsorbent medium (60) is disposed within at least one vessel, comprising a last step (26) wherein a last portion of an entire amount of the gas (51) to be filled into the sorption store (50) is fed at a maximum feed rate, said feed rate defined as an amount of gas (51) filled into the sorption store (50) per time unit, and wherein the last portion of the entire amount of the gas (51) to be filled into the sorption store (51) is the difference between at least 20% and 100%, in particular the difference between at least 40% and 100%, by weight of gas relating to the total weight of gas to be stored.

The present invention relates to a process for filling a sorption store with a gas, wherein at least one gas adsorbent medium is disposed within at least one vessel, comprising a last step, wherein a last portion of an entire amount of the gas to be filled into the sorption store is fed at a maximum feed rate, said feed rate defined as an amount of gas filled into the sorption store per time unit, and wherein the last portion of the entire amount of the gas to be filled into the sorption store is the difference between at least 30% and 100%, in particular the difference between at least 50% and 100%, by weight of gas relating to the total weight of gas to be stored. The invention additionally relates to a sorption store comprising a control system for effectuating the process for filling and to a vehicle comprising the sorption store.

Owing to the increasing scarcity of oil resources, research is increasingly being made to unconventional fuels such as methane, ethanol or hydrogen for operating an internal combustion engine or a fuel cell. For this purpose, vehicles comprise a storage vessel for keeping a stock of the fuel. For the storage of gas in stationary and mobile applications, the gas is stored in pressure vessels, often referred to as compressed natural gas (CNG) technique or in sorption stores, often referred to as adsorbed natural gas (ANG) technique. Sorption stores are also known as ANG tanks.

ANG has the potential to replace compressed natural gas CNG in mobile storage applications such as in vehicles. Although a substantial research effort has been devoted to ANG, very few studies evaluate the impact of heat of adsorptions on system performance. In turn, in ANG-applications a micro powder solid, such as activated carbon, is packed in a vessel to increase the storage density, enabling lower pressure operation with the same capacity. Adsorption is an exothermic process. Any adsorption or desorption is accompanied by a temperature change in an ANG-storage system. The heat of adsorption has a detrimental effect on performance during both filling cycles and discharge cycles. A temperature increase as high as 80° C. can occur during the filling cycle. A filling cycle normally will be performed in a fuel station, at least for mobile applications, where the released adsorption heat can be removed. Contrary to the filling cycle, the rate of discharge is dictated by the energy demand of the application. The filling time cannot be widely varied to moderate the impact of cooling during the use of ANG storage vessels.

Sorption stores comprise in particular adsorbent media having a large internal surface area, on which the gas is adsorbed. The gas is stored by adsorption on the adsorbent medium, in the cavities between the individual particles of the adsorbent medium and in parts of the vessel, which are not filled with adsorbent medium. The filled sorption store can be operated pressurized and non-pressurized. The selection of a suitable vessel depends on the applied maximum pressure. The higher the storage pressure, the more gas can be stored per volume.

Adsorption describes the attachment of atoms or molecules of a gaseous or liquid fluid onto the surface of a solid material, which is referred to as adsorbent medium for the purpose of the present invention. Terms like adsorbent, adsorber and adsorption medium are equally known for the denomination of the said solid material. The adsorption capacity of the adsorbent medium, defined by the ratio of the mass of the adsorbed gas or liquid to the mass of the adsorbent medium, strongly depends on temperature and is reduced with increasing temperature. In the aim of a maximal exploitation of the storage space, the temperature profile established in the adsorbent medium during the filling procedure has to be taken into consideration. Furthermore, an efficient adsorption allows a reduced filling time as the same amount of gas can be stored in a shorter time period. Hence, the maximum amount of stored gas can be increased when the available filling time is limited. During filling the sorption store with gas, two sources are relevant for a temperature increase in the vessel. These are the heat due to the compression of the gas and the heat liberated as a result of the exothermic adsorption. The generated heat directly depends on the amount of adsorbed gas. The more gas is adsorbed on the adsorbent medium, the more heat is liberated. And with an increasing adsorbed amount of gas on the adsorbent medium, the adsorption rate, defined as amount of gas adsorbed per unit of time, is reduced.

Besides, desorption is an endothermic process and heat has to be supplied when gas is taken from the sorption store. Heat management is therefore of great importance when sorption stores are used.

A crucial aspect for sorption stores in mobile applications is the limited space available for example on vehicles. Therefore, a high energy density in the sorption store is pursued in order to maximize the range a vehicle can cover with only one fill-up.

DE 10 2009 030 155 discloses a non-pressurized storage for hydrogen on the basis of nanostructured carbon and metal organic framework material (MOF). The amount of stored hydrogen is quantified internally in the cartridge.

WO 2009/071436 A1 is related to a method for storing gaseous hydrocarbons in a sorption reservoir. The temperature of the stored hydrocarbons, under filled conditions of the sorption reservoir, is lower than room temperature and higher than the evaporation temperature of the hydrocarbons. A device for storing gaseous hydrocarbons, comprising a sorption reservoir that is isolated towards the surroundings, is described. The sorption reservoir contains zeolite, activated carbon or metal-organic framework compounds.

DE10 2009 000 508 describes a sorption store equipped with a cooling jacket. This approach addresses the temperature dependency of the filling and the discharging procedure in order to exploit the storage space to a maximum.

DE 10 2008 043 927 discloses an apparatus for the storage of gas and a process for discharging a gas from a sorption store, wherein the gas is withdrawn at a constant temperature and afterwards compressed to a given working pressure. The process allows a complete emptying of the storage vessel without an energy consuming heating of the gas.

U.S. Pat. No. 7,059,364 discloses a method for a quick filling of a vehicle storage vessel with hydrogen. The empty vessel is filled stepwise until a pressure of more than 6000 psig is reached.

U.S. Pat. No. 5,771,948 describes a method and an apparatus for dispensing natural gas into a natural gas vehicle cylinder of a motor vehicle. The filling process for compressed natural gas (CNG) is addressed. The system is equipped with pressure sensors, temperature sensors and a mass flow meter in order to maximize the amount of gas injectable into the cylinder.

US 2005/0178463 discloses a method for quick filling a vehicle storage vessel with hydrogen according to the conventional compressed natural gas (CNG) technique. The disclosed method and system compensate the temperature increase in the vessel during filling. The filling with gas is conducted stepwise according to a particular algorithm.

US 2009/0261107 A1 is related to a motor vehicle comprising a gas tank. The vehicle is powered by a fuel cell system and/or an internal combustion engine. At least one gas tank is filled with a gaseous fuel, in particular with natural gas or hydrogen, whereby a metal organic framework (MOF) is arranged in the interior of the gas tank as a storage material for holding the fuel. A comparatively high storage density is obtained and sufficient space for luggage or loading is made available in the vehicle. This is achieved according to US 2009/0261107 A1 in that the gas tank which comprises the metal organic framework (MOF) is embodied as a compressed gas tank for storing the gaseous fuel under pressure.

The disadvantage of the known storage systems is that the capacity of the limited storage volume is not yet fully exploited. The energy density in the storage tank was enhanced either by the application of adsorbent material or by the application of a specific filling technique. A reduced efficiency of adsorption systems is particularly serious in mobile application, for example in motor vehicles like cars and trucks. Therefore, there is a continuing interest in providing a simple and efficient concept for filling the adsorption store taking the generated heat into consideration.

It is an object of the present invention to provide a process that enables a more efficient use of a given storage space by means of devices, which are known in the art and already existing in the relevant technical field. The invention allows motor vehicles to reach greater distances without a stop-over for filling and therefore to be less dependent on a dense network of filling stations.

For the purposes of the invention, sorption stores are stores, which comprise an adsorbent medium having a large surface area in order to adsorb gas and thereby store it. Sorption stores can store gas by both means of adsorption and means of compression of gas. Thus, heat is liberated during filling of the sorption store, while the desorption is activated by introduction of heat.

The adsorption stores, as known from the state of the art, are conventionally attached to a pressure pipe for filling, which provides a usually constant pressure. The gas to be stored is fed into the vessel at a usually constant pressure from the pressure pipe with the maximum feed rate until the pressure in the vessel has reached the predetermined storage pressure. According to the present invention the sorption store, comprising at least one closed vessel and a feeding device, is filled stepwise in at least two steps characterized by different feed rates. The feed rate is defined to be the amount of gas filled into the sorption store per time unit. A crucial feature of the invention is the last step of the filling process, wherein a last portion of the entire amount of the gas to be filled into the sorption store is fed at a maximum feed rate. The maximum feed rate is the technically possible maximum feed rate and depends on the filling devices on the vehicle and at the fuel station as well as on the pressure level provided at the fuel station. The last portion of the entire amount of the gas to be filled into the sorption store is the portion of gas that is fed at last into the sorption store to accomplish a complete filling of the sorption store and to reach the predetermined storage pressure. This last portion of the entire amount of the gas is quantified to be less than 70%, preferably less than 50% and in particular preferably less than 30% by weight of the gas relating to the total weight of the stored gas. This last portion of the entire amount of the gas is filled into the sorption store directly before the predetermined storage pressure is reached. For example in a case wherein a MOF A520 is used as adsorbent medium, a significant uptake of gas by adsorption is feasible until a pressure of approximately 120 bar in the vessel is reached. Subsequently, a feeding at the maximum feed rate is preferred between 120 bar and 250 bar. If the involved filling station is not able to effectuate such a pressure jump from 120 bar to 250 bar at the maximum feed rate, the pressure level to start the filling at the maximum feed rate can be chosen to be higher than 120 bar.

In a preferred embodiment of the invention, the last portion of the entire amount of the gas to be filled into the sorption store is fed at a maximum feed rate as soon as a pressure level of at least 100 bar, in particular of at least 150 bar, is reached in the vessel, whereas the average feed rate is reduced as long as the pressure in the vessel is below this pressure level.

In an embodiment of the invention, the process comprises a second step at least one step before the last step characterized by a feed rate, which is smaller than the maximum feed rate.

Before this last step the feed rate is reduced in order to provide time for the establishment of the adsorption equilibrium on the surface of the adsorbent medium. Additionally, the generated adsorption heat can be conducted to the outer walls of the vessel. Consequently, the surface of the adsorbent medium, where the adsorption occurs, is cooled and the adsorption capacity is therefore increased.

In a further embodiment, the process comprises a second step at least one step before the last step characterized by a variation of the fed amount of gas in a way that the pressure course in the vessel approaches the adsorption kinetics of the gas adsorbent medium.

Methods for determination of the adsorption kinetics are known by a person skilled in the art. The adsorption kinetics are determined for example with the help of pressure jump experiments or adsorptions balances (see “Zhao, Li and Lin, Industrial and Engineering Chemistry Research, 48 (22) 2009, pages 10015 to 10020”). The adsorption kinetic describes the course of the adsorption of a gas on an adsorbent medium with the time at isothermic and isobar conditions.

As the adsorption kinetic can often be approximated by an exponentially decaying function, which shows a steep slope in the beginning and which flattens until a convergence to the end value. An example for such an approximation is the function a·(1−e^{-bt}), wherein a and b are positive constants. The adsorption kinetic can equally be approximated by other functions as for example by a concave function, a function which is constant in certain sections, and a function which is linear in certain sections or a linear function which bonds the initial and the end value.

In a further preferred embodiment, the process comprises a first step, wherein a first portion of the entire amount of the gas to be filled into the sorption store is fed at a maximum feed rate and wherein the first portion of the entire amount of the gas to be filled into the sorption store is the difference between 0% and at least 30%, in particular the difference between 0% and 40%, by weight of gas relating to the total weight of gas to be stored. The first portion of the entire amount of the gas to be filled into the sorption store is the portion of gas that enters the sorption store at first during filling.

During this first step of the process, initially, the cavities of the adsorbent medium are filled with gas. The pressure in the vessel follows almost without any retard the pressure of the gas, which is filled into the vessel. In order to minimize the time consumption for the filling procedure this first step should be effectuated as fast as possible. During this first step a portion of the entire amount of the gas already adsorbs, whereby the temperature of the adsorbent medium and therefore the temperature of the gas increases.

Compared to conventional feeding strategies, whereby the gas is provided with a usually constant pressure from the filling pipe and the feed rate is maximal referring to the pressure provided in the filling pipe over the total filling time, a process according to the invention allows the feed of a greater amount of gas at the same time or shorter filling times for an equal amount of gas, respectively.

The feed rate of gas can be varied for example by approximating the entrance pressure of the gas to the corresponding function describing the adsorption kinetics for example by a corresponding switching of the valves. In a preferred embodiment of the invention, the course of the pressure during the step, characterized by a reduced feeding rate, is approximated to the adsorption kinetics by means of pressure swings.

In an embodiment of the invention the stored gas contains hydrocarbons and/or water, and combinations thereof. The stored gas contains preferably gas selected from the group consisting of methane, ethane, butane, hydrogen, propane, propene, ethylene, water and/or methane, and combinations thereof, in particular natural gas. In particular preferred is stored gas, which comprises methane as a main component.

Fuels can be stored in the sorption store of the invention and be provided by desorption to an internal combustion engine or a fuel cell for example. Methane is particularly suitable as fuel for internal combustion engines. Fuel cells are preferably operated using methanol or hydrogen.

In a preferred embodiment of the invention the gas adsorbent medium is a porous and/or microporous solid.

In an in particular preferred embodiment of the invention, the gas adsorbent medium is selected from the group consisting of activated charcoals, zeolites, activated alumina, silica gels, open-pore polymer foams and metal-organic frameworks, and combinations thereof. The gas adsorbent medium preferably comprises metal-organic frameworks (MOFs).

Zeolites are crystalline aluminosilicates having a microporous framework structure made up of AlO⁴⁻ and SiO₄ tetrahedra. Here, the aluminum and silicon atoms are joined to one another via oxygen atoms. Possible zeolites are zeolite A, zeolite Y, zeolite L, zeolite X, mordenite, ZSM (Zeolites Socony Mobil) 5 or ZSM 11. Suitable activated carbons are, in particular, those having a specific surface area above 500 m² g⁻¹, preferably above 1500 m² g⁻¹, very particularly preferably above 3000 m² g⁻¹. Such an activated carbon can be obtained, for example, under the name Energy to Carbon or MaxSorb.

Metal-organic frameworks (MOF) are known in the prior art and are described, for example, in U.S. Pat. No. 5,648,508, EP-A 0 790 253, M. O'Keeffe et al., J. Sol. State Chem., 152 (2000), pages 3 to 20, H. Li et al., Nature 402, (1999), page 276, M. Eddaoudi et al., Topics in Catalysis 9, (1999), pages 105 to 111, B. Chen et al., Science 291, (2001), pages 1021 to 1023, DE-A 101 11 230, DE-A 10 2005 053430, WO-A 2007/054581, WO-A 2005/049892 and WO-A 2007/023134. The metal-organic frameworks (MOF) mentioned in EP-A 2 230 288 A2 are particularly suitable for sorption stores. Preferred metal-organic frameworks (MOF) are MIL-53, Zn-tBu-isophthalic acid, Al-BDC, MOF 5, MOF-177, MOF-505, MOF-A520, HKUST-1, IRMOF-8, IRMOF-11, Cu-BTC, Al-NDC, Al-AminoBDC, Cu-BDC-TEDA, Zn-BDC-TEDA, Al-BTC, Cu-BTC, Al-NDC, Mg-NDC, Al-fumarate, Zn-2-methylimidazolate, Zn-2-aminoimidazolate, Cu-biphenyldicarboxylate-TEDA, MOF-74, Cu-BPP, Sc-terephthalate. Greater preference is given to MOF-177, MOF-A520, HKUST-1, Sc-terephthalate, Al-BDC and Al-BTC.

Apart from the conventional method of preparing the MOFs, as described, for example, in U.S. Pat. No. 5,648,508, these can also be prepared by an electrochemical route. In this regard, reference may be made to DE-A 103 55 087 and WO-A 2005/049892. The metal organic frameworks prepared in this way have particularly good properties in respect of the adsorption and desorption of chemical substances, in particular gases.

Particularly suitable materials for the adsorption in sorption stores are the metal-organic framework materials MOF A520, MOF Z377 and MOF C300.

MOF A 520 is based on aluminium fumarate. The specific surface area of a MOF A520, measured by porosimetry or nitrogen adsorption, is typically in the range from 800 m̂2/g to 2000 m̂2/g. The adsorption enthalpy of MOF A520 with regard to natural gas amounts to 17 kJ/mol. Further information on this type of MOF may be found in “Metal-Organic Frameworks, Wiley-VCH Verlag, David Farrusseng, 2011”.

MOF Z377, in literature also referred to as MOF type 177, is based on zinc-benzene-tribenzoate. The specific surface area of a MOF Z377, measured by porosimetry or nitrogen adsorption, is typically in the range from 2000 m̂2/g to 5000 m̂2/g. The MOF Z377 typically posses an adsorption enthalpy between 12 kJ/mol and 17 kJ/mol with respect to natural gas. MOF C300 is based on copper benzene-1,3,5-tricarboxylate and for example commercially available from Sigma Aldrich under the tradename Basolite® C300.

These MOFs can also be applied in form of pellets. The pellets can have a cylindrical shape with a length of 3 mm and diameter of 3 mm. Their permeability is preferably between 1·10̂−15 m̂2 and 3·10̂−3 m̂2. The porosity of the bed, which is defined as the ratio of the void volume between the pellets to the total volume of the vessel without considering the free volume within the pellets, is at least 0.2, for example 0.35.

Generally, a variety of materials can be applied and be combined as gas adsorbent medium, independently of their characteristics regarding their impact on the gas flow in the vessel, their packing density and their heat capacity. The gas adsorbent medium are preferably applied as pellets but can likewise be applied as powder, monolith or in any other form.

In an embodiment, the porosity of the adsorbent medium is preferably at least 0.2, for example 0.35. The porosity is defined here as the ratio of hollow space volume to total volume of any subvolume in the vessel of the sorption store. At a lower porosity, the pressure drop on flowing through the adsorbent medium increases, which has an adverse effect on the filling time.

In a preferred embodiment of the invention, the adsorbent medium is present as a bed of pellets and the ratio of the permeability of the pellets to the smallest pellet diameter is at least between 1*10̂−11 m̂2/m and 1*10̂−16 m̂2/m, preferably between 1*10̂−12 m̂2/m and 1*10̂14 m̂2/m, and most preferably 1*10̂−13 m̂2/m. The rate at which the gas penetrates into the pellets during filling depends on the rapidity with which the pressure in the interior of the pellets becomes the same as the ambient pressure. With decreasing permeability and increasing diameter of the pellets, the time for this pressure equalization and thus also the loading time of the pellets increases. This can have a limiting effect on the overall process of filling and discharging.

When gas is taken from the sorption store, rapid and constant provision of gas has to be ensured. The sorption store can be equipped with a feed device which comprises at least one passage through the vessel wall through which a gas can flow into the vessel. The feed device can comprise, for example, an inlet and an outlet, which can each be closed by means of a shut-off device.

The feed device can comprise means to vary the gas stream for example throttle valves or control valves, which can be located inside or outside of the vessel. The vessel can further comprise more than one passage through the vessel wall for example in order to lead the gas stream in optional subdepartments of the vessel or in order to provide separate passages for the filling and the discharge of the gas. Preferably, the same passage or the same passages are used for both, the discharge of the gas and the filling of the vessel.

Depending on the installation space available and the maximum permissible pressure in the vessel, different cross-sectional areas are suitable for the cylindrical vessel, for example circular, elliptical or rectangular. Irregularly shaped cross-sectional areas are also possible, e.g. when the vessel is to be fitted into a hollow space of a vehicle body. For high pressures above about 100 bar, circular and elliptical cross sections are particularly suitable. The vessel size vary according to the application. Diameters of the vessel of approximately 50 cm are typical for tanks in trucks and approximately 20 cm for tanks in cars, respectively. In cars fill volumes between 20 liters and 40 liters are provided, whereas tanks of a volume between 500 liters and 3000 liters can be found in trucks.

The vessel can be characterized by an elongated form and it can be installed in a horizontal position, which is preferred. Besides a substantially horizontally mounted vessel, a vertical installation is likewise feasible. In a further embodiment, the vessel of the sorption store has a cylindrical shape and optionally a dividing element is arranged essentially coaxially to the cylinder axis.

The choice of the wall thickness of the vessel and of the dividing elements is dependent on the maximum pressure to be expected in the vessel, the dimensions of the vessel, in particular its diameter, and the properties of the material used. Materials for a vessel of sorption store are variable. Preferred materials are for example steel. In the case of an alloy steel vessel having an external diameter of 10 cm and a maximum pressure of 100 bar, for example, the minimum wall thickness has been estimated as 2 mm (in accordance with DIN 17458). A double wall can be provided. The gap width of the double walls is selected so that a sufficiently large volume flow of the refrigerant can flow through them. It is preferably from 2 mm to 10 mm, particularly preferably from 3 mm to 6 mm.

In an embodiment of the invention, the at least one vessel is a pressure vessel for the storage of gas at a pressure in the range up to 500 bar, preferably in a range of 1 bar to 400 bar, most preferably in a range of 1 bar to 250 bar and in particular preferably in a range of 1 bar to 100 bar.

The vessel is usually cooled during filling and/or heated during discharging. As a result, larger amounts of gas can be adsorbed or desorbed in the same time.

An improvement in heat transfer can be achieved when not only the vessel wall but also optional at least one dividing element, or in the case of a plurality of dividing elements one or more thereof, are cooled or heated. For this purpose, the at least one dividing element or a plurality of dividing elements, in particular all dividing elements present, can be configured as double walls so that a refrigerant can flow through them.

A configuration with double-walled channel walls has the advantage that for switching from cooling to heating, it is merely necessary for the coolant to be changed or its temperature to be altered appropriately. Thus, this embodiment is, in mobile use, equally suitable for filling with fuel and for the traveling mode. A pump can convey the refrigerant in the cooling circuit. A pumping power of the pump can be varied as a function of a fill level of the sorption store.

Depending on the temperature range, which is appropriate for the cooling or heating of the gas in the sorption store, different heat carrier media may apply, for example water, glycol, alcohols or mixtures thereof. Corresponding heat carrier media are known by a person skilled in the art.

The time required for filling the sorption store is essentially determined by the material properties of the adsorbent medium, in particular by its adsorption kinetics. Another impact factor is the maximum temperature which is reached during filling, which equally depends on the material properties, in particular on the adsorption enthalpy. The determination of the pressure level onto which the filling is effectuated at a maximum feed rate in a first step as well as the way of the following pressure enhancement is preferably adapted to the adsorption kinetics, the adsorption enthalpy and the heat conduction to the walls of the vessel. In case of a fast heat conduction of the generated adsorption heat higher pressures for pressure level between the first and the following step are preferred in order to minimize the total time required for the filling. Depending on the adsorption kinetics and the heat conduction this pressure limit can be between 30% and 90% of the predetermined storage pressure. The pressure level at the end of the first step is further limited by the temperature increased due to the adsorption.

In a preferred embodiment of the invention, the maximum adsorption capacity of the gas adsorbent medium is reached at a pressure of less than 250 bar, in particular at a pressure of less than 200 bar.

In a in particular preferred embodiment, the maximum adsorption capacity of the gas adsorbent medium is reached between 100 bar and 150 bar. After the maximum adsorption capacity is reached the adsorption capacity is almost independent from pressure but still depends on temperature. A feeding of the gas into the sorption store at the maximum feed rate is preferred as soon as the maximum adsorption capacity is reached or when the sorption store differs less than 20% from the pressure, where the maximum adsorption capacity of the gas adsorbent medium is reached. The maximum adsorption capacity in the purpose of the invention can be the theoretical maximum adsorption capacity as well as the technically relevant maximum adsorption capacity, which is typically approximately two thirds of the theoretical maximum adsorption. After the technically relevant maximum adsorption capacity is reached the adsorption capacity increases only very slowly with increasing temperature and the slope of the adsorption isotherms approximates zero.

In a preferred embodiment of the invention the temperature of the gas is measured in at least one point inside of the vessel. The fed amount of gas is adapted; if necessary, to this measured value in order to respect a given maximum temperature.

Preferably, a mass flow into and/or out of the sorption store is measured by means of at least one mass flow meter at the inlet and/or the outlet of the sorption store.

In a further preferred embodiment, the sorption store comprises the inlet and the outlet, which can each be closed by means of a shut-off element and during the process for filling of the sorption store the following steps are carried out:

(a) closing of the outlet shut-off element and opening of the inlet shut-off element,

(b) introduction of gas to be stored under a predetermined pressure through the inlet,

(c) rapid opening of the outlet shut-off element with the inlet shut-off element open so that a gas flow having a predetermined flow rate is established in the vessel,

(d) reduction of the flow rate as a function of the adsorption rate of the gas adsorbed in the sorption store and

(e) complete closing of the outlet shut-off element.

Preferably, the outlet shut-off element is closed completely when the mass flow into the sorption store and the mass flow out of the sorption store differ by less than 5%.

Preferably, the flow rate of the gas in the vessel is set as a predetermined multiple of the adsorption rate over time. The multiple is preferably from 1.5 to 100, particularly preferably from 3 to 40. At excessively small values of the multiple, there is a risk of the heat not being able to be removed sufficiently. At very high values, an unnecessarily large quantity of energy has to be expended in order to ensure the high flow without an adequate gain in respect of heat removal being able to be achieved.

The present invention also discloses a sorption store, i.e. an ANG-storage reservoir, which contains at least one adsorption material, such as metal organic framework (MOF), which is equipped with a filling device as described before. The invention further includes a vehicle comprising a sorption store with control system for a process according to the invention.

### BRIEF DESCRIPTION OF THE DRAWINGS:

The figures show:

FIG. 1 adsorption isotherm at different temperatures;

FIG. 2 pressure course for conventional and inventive filling process;

FIG. 3 pressure course with approximation to the adsorption kinetics;

FIG. 4 pressure course with a hold of feed;

FIG. 5 first illustrative embodiment of the process according to the invention;

FIG. 6 second illustrative embodiment of the process according to the invention;

FIG. 7 embodiment of a storage unit according to the invention;

FIG. 8 vehicle with a storage unit according to the invention.

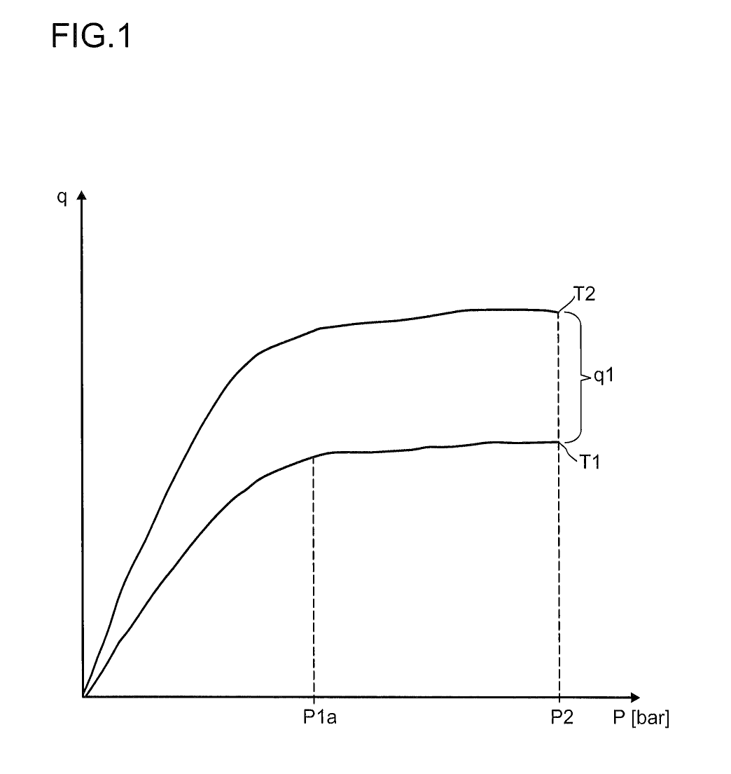

FIG. 1 shows the isotherms of a gas adsorbent medium for two different temperatures. The course the adsorption capacity q for methane expressed by the ratio of the mass of adsorbed methane to the mass of the adsorbent medium, metal organic framework, over the pressure p in bar. Both graphs are characterized by a steep slope for small pressures. The slope flattens with higher pressures until a maximum adsorption capacity is reached for pressures higher than P1a, for example with P1a =150 bar. P2 labels the predetermined storage pressure. For all pressures the adsorption capacity is higher at the smaller temperature which is T2, with for example T2 =293 K, compared to the higher temperature T1, which equals for example T1 =327 K. The characteristic point for the design of the storage process is point 1a, where the maximum adsorption capacity is apparently reached and the slope approximates 0. For pressures higher than P1a the adsorption capacity is more dependent on temperature than on pressure. Consequently, a further enhancement of the adsorption capacity can only be obtained by a variation in temperature and not any longer by an increase in pressure. The corresponding pressure to point 1a is depending on the gas to be adsorbed, the adsorbent medium and the temperature. In a preferred embodiment of the invention the vessel is filled at maximum feed rate once the pressure P1a is reached. The impact of the desired temperature drop from T1 to T2 on the adsorption capacity and therefore on the energy density in the storage vessel can be directly read from the distance q1, which describes the difference in the capacity of the adsorbent medium for methane for a pressure drop of 34 K.

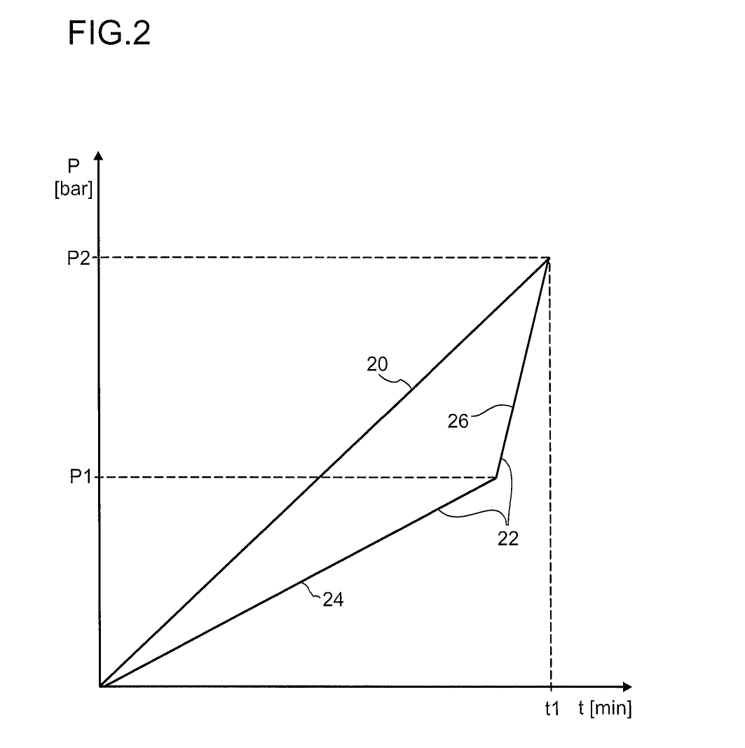

FIG. 2 shows the pressure course with the time for a conventional filling process 20 and a filling process according to the invention. The slope corresponds to the feed rate 1. For both processes the predetermined storage pressure P2 of for example 250 bar is obtained after time t1. The pressure increase is effectuated for the conventional filling process in a linear manner, whereas the process according to the convention applies a pressure increase in at least two different steps 24 and 26. The difference between these two steps is the feed rate and therefore the slope of the graph indicating the pressure increase. In the step 24 the filling speed is reduced until a pressure P1 of for example 150 bar is reached. This pressure limit of P1 is chosen in this example according to the corresponding isotherm and P1 is the pressure level P1a, where the slope of the isotherm approximates zero and no further enhancement of the adsorption capacity can be realized by pressure increase. A reduced filling speed in step 24 of the filling process offers the advantage that more time is given for heat conduction to the external walls of the vessel. As a result, the temperature on the surface of the adsorbent medium is reduced. As illustrated in FIG. 1, a reduced temperature on the adsorbent medium surface directly corresponds to an enhancement in adsorbent medium capacity. The feed rate is enhanced as soon as a maximum adsorption capacity is reached. The gas filled in at this step 26 is stored only by compression and no longer by adsorption. Compression also leads to a generation of heat. Hence, it is advantageous to fill at a maximum feed rate, in the aim to prevent a desorption of the already adsorbed gas due to the temperature increase caused by compression. Further, the additionally consumed time due to reduced feed rate in step 24 can be compensated in step 26. In a conclusion, a higher adsorption capacity can be obtained in step 24 due to a reduced temperature on the adsorbent medium surface resulting from a better ratio of adsorption rate and heat conduction. A further enhancement of the adsorption capacities is realized in stage 26 by a fast compression with a reduced heating of the adsorbent medium surface until the feeding valve is closed.

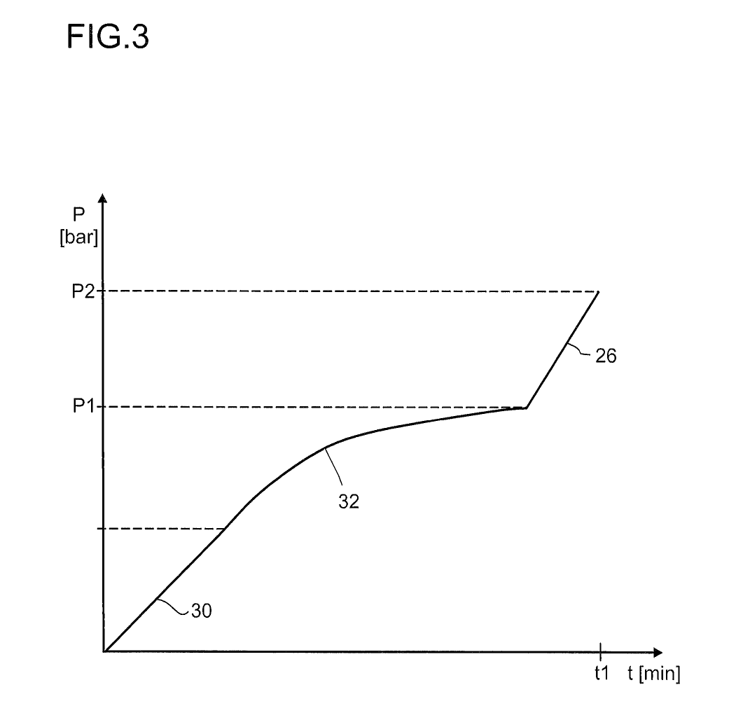

FIG. 3 shows a further embodiment of the invention, where in the step 24 is further divided into steps 30 and 32. Initially, the gas is filled at a maximum feed rate in step 30 in order to fill the cavities in the vessel and in the adsorbent medium. As soon as a relevant amount of gas molecules is present in the vessel the adsorption rate, which is defined by the number of adsorbed molecule per time, is enhanced and the generated adsorption heat leads to a temperature increase. The required time for the heat conduction to the external walls of the vessel is taken into consideration and the feed rate is adapted to the adsorption kinetics in step 32. As soon as a maximum adsorption capacity is reached at P1, the last portion of the entire amount of the gas can be filled in, again with at a maximum feed rate, in step 26. The advantage of this embodiment is a combination of the time saving filling strategy of steps 30 and 26 with the capacity enhancing strategies of step 32 and 26.

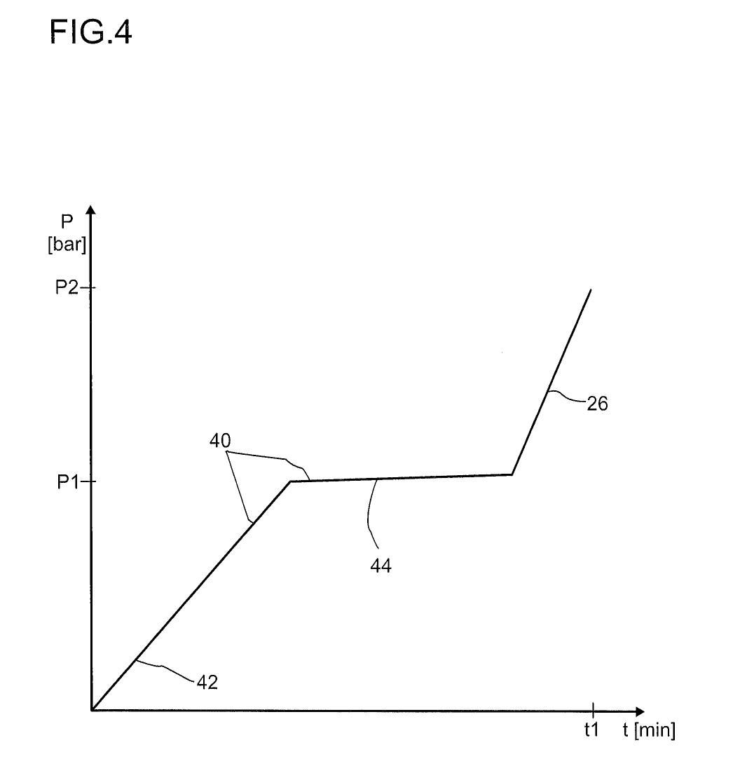

In a further embodiment of the invention illustrated by FIG. 4 the step 26, characterized by a maximum feed rate, is proceeded by a step 40 with a reduced average feed rate. The step 40 is divided into the two steps 42 and 44. Step 44 represents a pause in filling, where no further gas is fed to the vessel for a certain period of time. The aim is to allow the heat of adsorption to be conducted to the external walls of the vessel and therefore to let the surface of the adsorbent medium cool down.

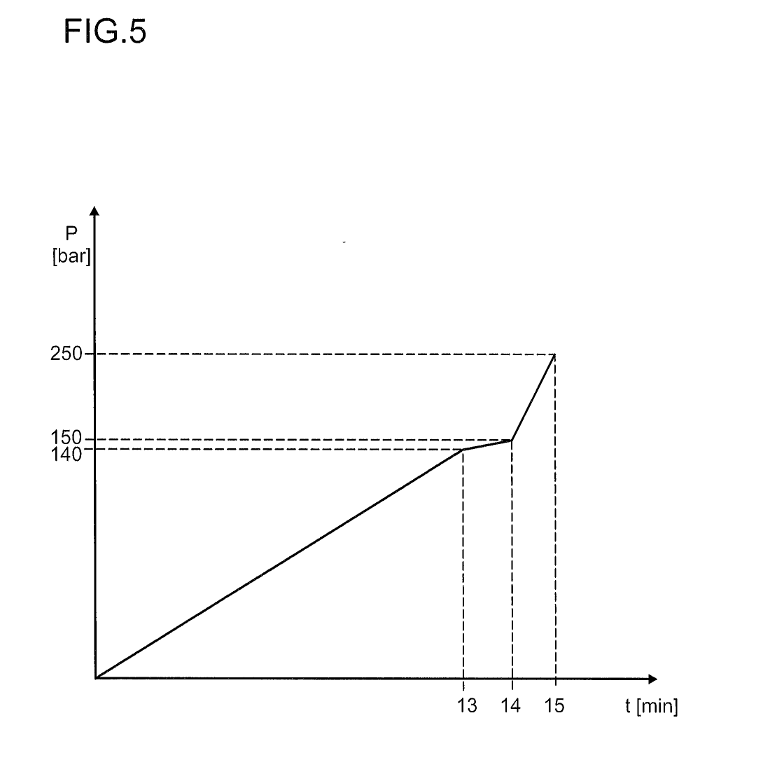

FIG. 5 shows a first illustrative embodiment of the process according to the invention, wherein a last portion of the entire amount of the gas 51 is filled at a maximum feed rate between the pressure levels of 150 bar and 250 bar within 1 minute. The pressure increase by a first portion of the entire amount of the gas from 1 bar to 140 bar is effectuated at a slower feed rate within 13 minutes. The pressure increase from 140 bar to 150 bar is very slow within 1 minute order to establish an adsorption equilibrium.

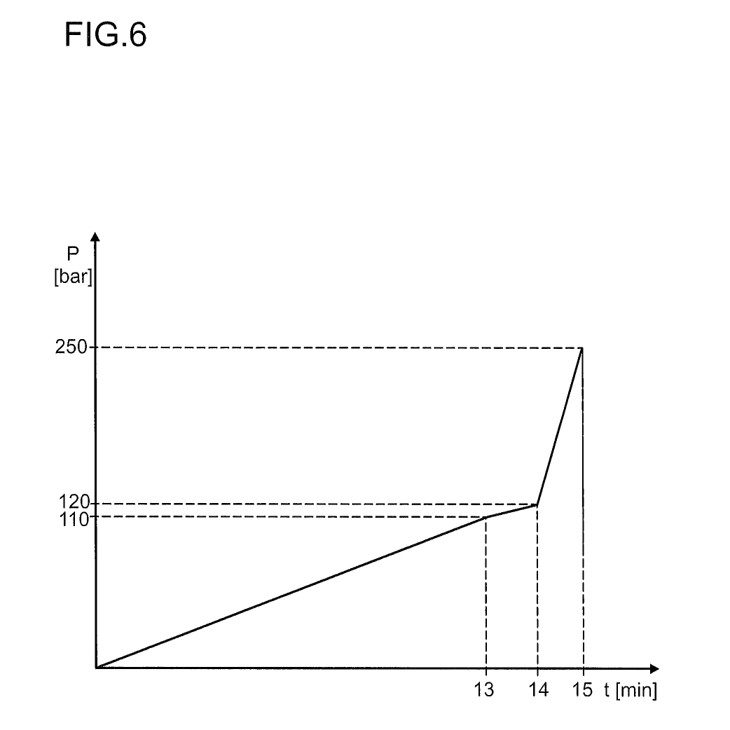

FIG. 6 shows a second illustrative embodiment of the process according to the invention, wherein a last portion of the entire amount of the gas 51 is filled at a maximum feed rate between the pressure levels of 120 bar and 250 bar within 1 minute. The pressure increase by a first portion of the entire amount of the gas from 1 bar to 110 bar is effectuated at a slower feed rate within 13 minutes. The pressure increase from 110 bar to 120 bar is very slow in 1 minute in order to establish an adsorption equilibrium. This embodiment is especially relevant where a corresponding performance in gas supply can be provided from the filling station and where the pressure jump from 120 bar to 250 bar is technically feasible.

Alternatively, a first portion of the entire amount of the gas 51 to be filled into the sorption store (50) can be fed at the maximum feed rate until a pressure of 120 bar is reached and the pressure can be increased subsequently from 120 bar to 130 bar in 60 seconds. Subsequently the pressure can then be increased from 130 bar to 250 bar by the application of the maximum feed rate.

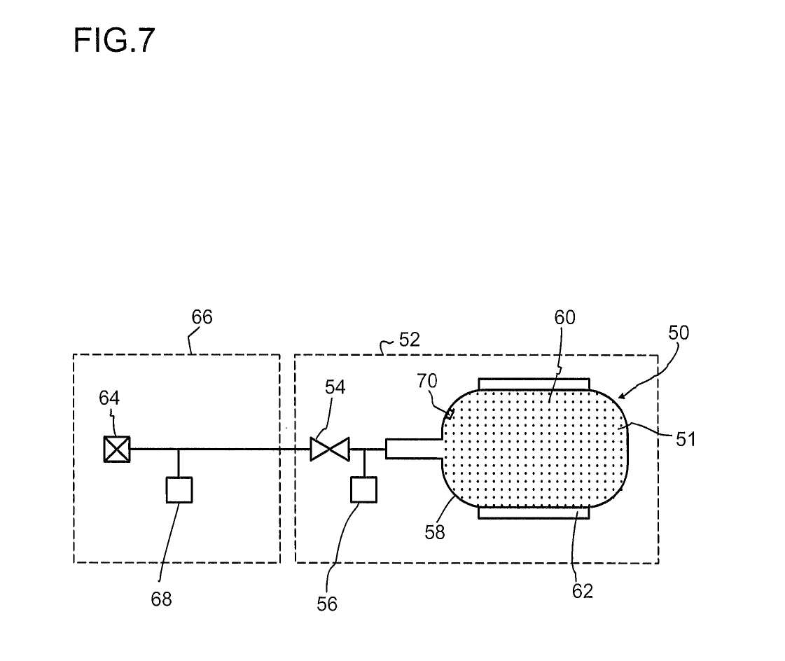

FIG. 7 shows a storage device with a sorption store 50 which can be filled with gas 51 according to the invention. The onboard facilities 52 that can be installed on a vehicle in particular on a truck, comprise a valve 54, a pressure sensor 56 and a pressure vessel 58, which is filled with gas adsorbent medium 60. The pressure vessel 58 is equipped with a double jacket 62, which realizes an affective heat exchange with the surrounding. The filling station 64 is located off-board 66 and can provide a further pressure sensor 68 in the illustrated embodiment the control system for the filling speed comprising a valve 54 and a pressure sensor 56 is located on-board. In an alternative embodiment this control system can equally be provided off-board. On the filling station side a great amount of gas is hold available under a pressure that is higher than the predetermined storage pressure. The gas is filled from the station store 64 via a valve 54 into the sorption store 50. During the filling process the pressure in the vessel is monitored by the pressure sensor 56 and additionally, if desired, the temperature is monitored by a temperature sensor 70. This data is used to control the valve 54 and to adjust the feed rate according to the filling status. The controlled valve 54 allows a stepwise filling of the sorption store 50 according to the invention.

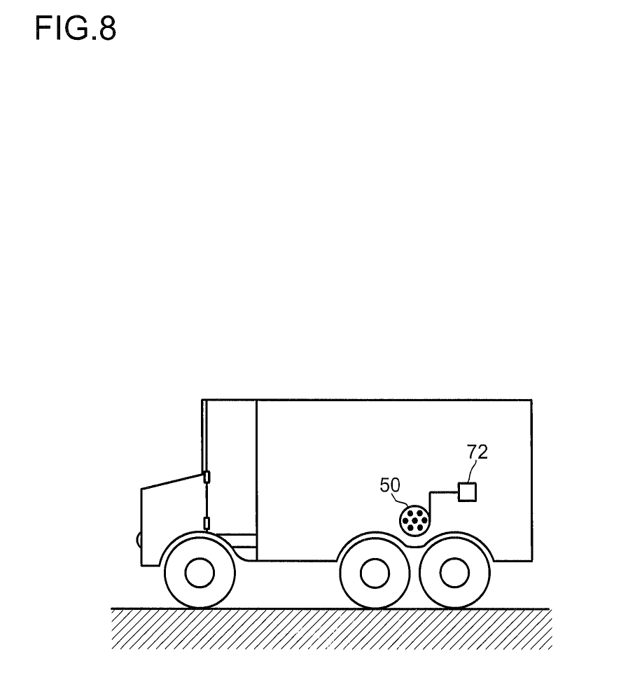

FIG. 8 shows a vehicle 74 comprising a sorption store 50 with control system 72. All instruments required for a process according to the invention are carried on-board and conventional filling stations for compressed natural gas (CNG) can be used without any modification of the devices provided at the station.

### Theoretical Comparative Examples

In the theoretical case that the temperature is kept constant at 20° C. during filling, a storage vessel with a volume of 534 liter and filled with the metal organic framework material MOF Z377 can store 103 kg of natural gas at a pressure of 250 bar.

In the theoretical case that the temperature is kept constant at 20° C. during filling, a storage vessel with a volume of 534 liter and filled with the metal organic framework material MOF A520 can store 66 kg of natural gas at a pressure of 150 bar.

### Comparative Example 1

A storage vessel with a volume of 534 liter is filled with the metal organic framework material MOF Z377. The sorption store is filled according to the conventional process with a linear pressure increase. 102 kg of natural gas can be stored in this sorption store.

### Example 1

A storage vessel with a volume of 534 liter is filled with the metal organic framework material MOF Z377. The pressure is enhanced up to a pressure limit of 150 bar, taking into account that for numerous metal organic framework materials a further pressure enhancement over 100 bar does not cause a further enhancement in adsorption capacity. Subsequently, the pressure is increased within 60 seconds to the predetermined storage pressure of 250 bar. The pressure increase from 150 bar to 250 bar would cause a temperature increase of about 40° C. for an empty store (CNG tank). In a storage vessel filled with metal organic framework material MOF Z377 the increase in pressure from 150 bar to 250 bar results in a temperature increase of 24° C. under the assumption that the gas is only compressed and no adsorption occurs at this stage. With this stepwise strategy a surplus of 4% by weight of gas can be stored in the vessel compared to the comparative example 1. 106 kg of natural gas can be stored in this storage vessel when a process according to the invention is applied.

The pressure increase from 150 bar to 250 bar in 60 seconds exploits the fact that at this feed rate the adsorption kinetics and the heat transfer from the gaseous phase to the solid adsorbent medium are not sufficient to alter and to reduce the adsorbed amount of gas on the adsorbent medium. The feed rate was fast compared to the metal organic framework material kinetics, which was assumed to be about 100 second, indicating the time required to reach equilibrium adsorption conditions.

### Comparative Example 2

A storage vessel with a volume of 534 liter is filled with the metal organic framework material A520. The vessel is filled with natural gas from 1 bar to 150 bar within 16 minutes. 58 kg of natural gas can be stored in this sorption store.

### Example 2

A storage vessel with a volume of 534 liter is filled with the metal organic framework material A520 is used for the storage of natural gas as described in the comparative example 2. This time, the pressure is increased at a reduced feed rate until a pressure limit of 100 bar is reached. The pressure increase from 100 bar to 150 bar is effectuated in 60 seconds. A surplus of 2% by weight of the gas can be stored in the sorption store compared to the comparative example 2. 59 kg of natural gas can be stored in this storage vessel when a process according to the invention is applied.

### Comparative Example 3

A storage vessel with a volume of 40 liter was filled with the metal organic framework material Z377 in form of pellets with a size of 3 mm. The storage vessel was equipped with an inlet and an outlet at the same end of the storage vessel. The inlet comprised an inlet shut-off element and the outlet comprised an outlet shut-of element. A gas comprising 91,9% methane was filled into the storage vessel. The pressure in the storage vessel was increased to 200 bar in 75 seconds. 5.7 kg of the gas were stored in the storage vessel.

### Example 3

The storage vessel according to comparative example 3 was filled with the gas comprising 91,9% methane. This time, the pressure was increased to 100 bar in approximately 30 seconds. Then, the pressure of 100 bar was hold constant in the storage vessel for 4 minutes and at the same time the outlet shut-off element was opened and the steps (c) to (e) as described above were carried out, generating a flow through regime in the storage vessel. The inlet shut-off element and the outlet shut-off element were open simultaneously for the 4 minutes. The total mass of gas already stored in the storage vessel was further increased from approximately 3.25 kg to 5.5 kg within this 4 minutes. The temperature of the metal organic framework material, measured in a central position in the storage vessel, decreased. After 4 minutes, a mass flow into the storage vessel and a mass flow out of the storage vessel differed by less than 5% and the outlet shut-off element was closed. Then, the pressure in the storage vessel was further increased from 100 bar to 200 bar within 30 seconds. 7.6 kg of the gas were stored in the storage vessel.

### REFERENCE NUMERALS

q adsorption capacity
p pressure
P1a pressure in point 1a
P2 predetermined storage pressure
T2 temperature: 293 K
T1 temperature: 327 K
1a point the maximum adsorption capacity is apparently reached
P1a pressure at point 1a
q1 difference in the capacity for a pressure drop of 34 K.
20 conventional filling process
22 filling process according to the invention
t1 time required to reach P2
P1 pressure where feed rate is changed
24 step with reduce feed rate
26 step with maximum feed rate
30 initial step with maximum feed rate
32 step with feed rate adapted to the adsorption kinetics
40 step with reduced average feed rate
42 substep of 40
44 pause in filling
50 sorption store
51 gas
52 on-board facilities
54 valve
56 pressure sensor
58 pressure vessel
60 gas adsorbent medium
62 double jacket
64 filling station
66 off-board facilities
68 further pressure sensor
70 temperature sensor
72 control system
74 vehicle

1-18. (canceled)

19. A process for filling a sorption store with a gas, wherein at least one gas adsorbent medium is disposed within at least one vessel, comprising a last step, wherein a last portion of an entire amount of the gas to be filled into the sorption store is fed at a maximum feed rate, said feed rate defined as an amount of gas filled into the sorption store per time unit, and wherein the last portion of the entire amount of the gas to be filled into the sorption store is the difference between at least 20% and 100%, by weight of gas relating to the total weight of gas to be stored and the last portion of the entire amount of the gas to be filled into the sorption store is fed at a maximum feed rate as soon as a pressure level (P1) of at least 100 bar is reached in the vessel, wherein the average feed rate is reduced as long as the pressure in the vessel is below this pressure level (P1).

20. The process according to claim 19, wherein the last step is started when a pressure in the sorption store differs less than 20% from a pressure, at which a maximum adsorption capacity of the at least one gas adsorbent medium is reached.

21. The process according to claim 19, comprising a second step at least one step before the last step characterized by a feed rate which is smaller than the maximum feed rate.

22. The process according to claim 19, comprising a second step at least one step before the last step characterized by a variation of the fed amount of gas in a way that the pressure course in the vessel approaches the adsorption kinetics of the gas adsorbent medium.

23. The process according to claim 19, comprising a first step, wherein a first portion of the entire amount of the gas to be filled into the sorption store is fed at a maximum feed rate and wherein the first portion of the entire amount of the gas to be filled into the sorption store is the difference between 0 and at least 30%, by weight of gas relating to the total weight of gas to be stored.

24. The process according to claim 19, wherein a maximum adsorption capacity of the gas adsorbent medium is reached at a pressure of less than 250 bar.

25. The process according to claim 19, wherein a first portion of the entire amount of the gas to be filled into the sorption store is fed at the maximum feed rate until a pressure of 120 bar is reached, wherein the pressure is increased subsequently from 120 bar to 130 bar in 60 seconds and wherein the pressure is increased subsequently from 130 bar to 250 bar at the maximum feed rate.

26. The process according to claim 19, wherein the gas adsorbent medium is a porous and/or microporous solid.

27. The process according to claim 19, wherein at least one gas adsorbent medium is present as a bed of pellets and wherein the ratio of the permeability of the pellets to the smallest pellet diameter is at least between 1*10⁻¹¹ m²/m and 1*10⁻¹⁶ m²/m.

28. The process according to claim 19, wherein the gas adsorbent medium is selected from the group consisting of activated charcoals, zeolites, activated alumina, silica gels, open-pore polymer foams and metal-organic frameworks, and combinations thereof.

29. The process according to claim 19, wherein the stored gas contains hydrocarbons, water, or combinations thereof.

30. The process according to claim 19, wherein the stored gas contains gas selected from the group consisting of methane, ethane, butane, hydrogen, propane, propene, ethylene, water, methane, and combinations thereof.

31. The process according to claim 19, wherein the stored gas comprises methane as a main component.

32. The process according to claim 19, wherein the gas is stored under pressure in the range of 1 bar to 100 bar.

33. The process according to claim 19, wherein the gas is stored under pressure in the range of 1 bar to 400 bar.

34. A sorption store comprising a control system for effectuating the process according to claim 19.

35. A vehicle comprising a sorption store and comprising a control system for the process according to claim 19.

36. The process according to claim 19, wherein the stored gas contains natural gas.

37. The process according to claim 19, wherein at least one gas adsorbent medium is present as a bed of pellets and wherein the ratio of the permeability of the pellets to the smallest pellet diameter is at least between 1*10⁻¹² m²/m and 1*10⁻¹⁴ m²/m.

38. The process according to claim 19, wherein a maximum adsorption capacity of the gas adsorbent medium is reached at a pressure of less than 200 bar.

39. The process according to claim 19, comprising a first step, wherein a first portion of the entire amount of the gas to be filled into the sorption store is fed at a maximum feed rate and wherein the first portion of the entire amount of the gas to be filled into the sorption store is the difference between 0% and 60%, by weight of gas relating to the total weight of gas to be stored.

40. A process for filling a sorption store with a gas, wherein at least one gas adsorbent medium is disposed within at least one vessel, comprising a last step, wherein a last portion of an entire amount of the gas to be filled into the sorption store is fed at a maximum feed rate, said feed rate defined as an amount of gas filled into the sorption store per time unit, and wherein the last portion of the entire amount of the gas to be filled into the sorption store is the difference between at least 40% and 100%, by weight of gas relating to the total weight of gas to be stored and the last portion of the entire amount of the gas to be filled into the sorption store is fed at a maximum feed rate as soon as a pressure level (P1) of at least 150 bar, is reached in the vessel, wherein the average feed rate is reduced as long as the pressure in the vessel is below this pressure level (P1).

41. The process according to claim 19, wherein the gas is stored under pressure in the range of 1 bar to 250 bar.
